(19) United States
(12) Patent Application Publication
(10) Pub. No.: US 2007/0023334 A1
(43) Pub. Date: Feb. 1, 2007

(54) Apparatus, a system and a method relating to hemodialysis, hemodiafiltration, hemofiltration or peritoneal dialysis

(75) Inventors: Hans Hallstadius, Lund (SE); Gert-Inge Bertinsson, Lund (SE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: GAMBRO LUNDIA AB, Lund (SE)

(21) Appl. No.: 10/568,086

(22) PCT Filed: Sep. 13, 2004
(86) PCT No.: PCT/SE04/01313

§ 371 Date: Feb. 13, 2006

Related U.S. Application Data
(60) Provisional application No. 60/505,762, filed on Sep. 26, 2003.

(30) Foreign Application Priority Data
Sep. 23, 2003 (SE) 0302520-2

(51) Int. Cl. B01D 61/32

(52) U.S. Cl. 210/94; 210/96.2; 210/321.71; 210/647

(57) ABSTRACT

The invention relates to an apparatus for hemodialysis, hemodiafiltration, hemofiltration or peritoneal dialysis. The apparatus comprises at least one conduit (10, 14) in which a dialysis and/or infusion fluid is intended to flow. The apparatus has a measurement unit (48) for measuring at least one optically active substance in the fluid. The measurement unit (48) is arranged to measure the concentration of the substance in said fluid by measuring the influence said substance in the fluid has on a polarized beam of light which is transmitted through said fluid. The invention also concerns a system including such an apparatus as well as a method of carrying out a measurement of the concentration of an optically active substance in a dialysis and/or infusion fluid.

### BACKGROUND OF THE INVENTION

The invention relates to an apparatus for hemodialysis, hemodiafiltration, hemofiltration or peritoneal dialysis. The apparatus comprises at least one conduit in which a dialysis and/or infusion fluid is intended to flow. The apparatus comprises a measurement unit for measuring at least one substance in said fluid.

The invention also concerns a system including such an apparatus as well as a method concerning hemodialysis, hemodiafiltration, hemofiltration or peritoneal dialysis.

Hemodialysis is a treatment designed to correct the chemical composition of blood by removing accumulated metabolic products and adding buffer in a process of diffusion through a natural or synthetic semi-permeable membrane.

A conventional kind of hemodialysis apparatus is well known to a person skilled in the art. An example of such an apparatus is described in connection with FIG. 1 in EP-A2-904 789. A hemodialysis apparatus is used to treat a patient suffering from kidney failure. In a dialysis apparatus a dialysis fluid (dialysis solution) is prepared. The dialysis fluid is used to achieve dialysis in a dialyser that is part of the hemodialysis apparatus. The dialysis fluid can be prepared in the apparatus by feeding water and one or more concentrates to the apparatus. The apparatus may also be arranged to provide the patient with an infusion solution. Such an infusion solution may be the same or different than the dialysis fluid. Since a hemodialysis apparatus is well known to a person skilled in the art, it will not be described in all its details here.

Hemofiltration is a treatment designed to remove accumulated metabolic products from blood by the process of convective transport as a consequence of ultrafiltration through a semi-permeable membrane of high-flux type; the volume of filtered fluid exceeding the desired weight loss is replaced by sterile pyrogen-free infusion solution. In a pure hemofiltration process, normally no dialysis fluid is used.

Hemodiafiltration is a treatment designed to remove accumulated metabolic products from blood by a combination of diffusive and convective transport through a semi-permeable membrane of high-flux type; fluid is removed by ultrafiltration and the volume of filtered fluid exceeding the desired weight loss is replaced by sterile, pyrogen-free infusion solution.

There exist apparatuses that can be used for both hemodialysis and hemofiltration, as well as for hemodiafiltration.

There also exist apparatuses for peritoneal dialysis. In peritoneal dialysis no dialyser that is part of an apparatus is needed. Instead the peritoneum of the patient is used as a dialysis membrane. Also in an apparatus for peritoneal dialysis, a dialysis fluid and/or an infusion fluid is added.

It should also be mentioned that it is known to provide apparatuses of the above described kinds with a measurement unit for measuring some substance in the dialysis or infusion fluid. The apparatus may for example be provided with a measurement unit that measures the conductivity of the dialysis fluid in order to estimate the concentration of the dialysis concentrate that is mixed with water in the apparatus.

Often a concentrate including glucose or a similar substance, is added to apparatuses of the above mentioned kinds. The glucose is often provided as a concentrate that is fed to the apparatus. The glucose concentrate can be provided in different kinds of containers from which the concentrate is fed to the apparatus. Since such concentrates may be provided with different glucose concentrations, it is important to ensure that a concentrate of the correct glucose concentration is fed to the apparatus. Sometimes, the concentrate including glucose is provided in a flexible fluid bag. Such a bag may comprise a plurality of compartments. The compartments are to be connected to each other such that the fluids of the different compartments mix with each other before the fluid is fed to the apparatus. In such a fluid bag, the glucose concentrate may be included in one compartment. In this kind of fluid bag, it is important to ensure that the contents of the different compartments have been mixed with each other before the fluid is fed to the apparatus. Due to the human factor, it is possible to make mistakes, such that a container with the wrong concentration of glucose is connected to the apparatus in question, or such that a flexible fluid bag with different compartments is connected to an apparatus without the contents of the different compartments having been properly mixed with each other before the fluid is fed to the apparatus.

### SUMMARY OF THE INVENTION

An object of the present invention is to provide an apparatus of the kind that is defined in the first paragraph above and which makes it possible to measure the concentration of a substance in a fluid that is fed to the apparatus or that is transported in the apparatus. A further object is to provide an apparatus with means which makes it possible to avoid the above mentioned possible mistakes concerning the concentration of a substance added to the apparatus. This substance can be glucose or a similar substance. A further object is to provide such means that are comparatively simple and inexpensive to implement in an apparatus of the above kind. A further object is to provide such an apparatus which in a reliable manner detects whether the concentration of such a substance in the fluid is correct.

The above objects are achieved by an apparatus of the kind that is defined in the first paragraph above and that is characterised in that the substance that is to be measured is an optically active substance, wherein the measurement unit is arranged to measure the concentration of said substance in said fluid by measuring the influence said substance in the fluid has on a polarised beam of light which is transmitted through said fluid.

The inventor of the present invention has thus realised that since a substance such as glucose is an optically active substance, an apparatus of the above mentioned kind can be provided with a measurement unit that measures the influence that the substance in the fluid has on a polarised beam of light. With such a measurement unit, it can be ensured that a substance of the correct concentration is fed into or through the apparatus. Such a measurement unit can also be constructed quite simply and does not have to be expensive.

In this context it can be mentioned that it is known that for example glucose is an optically active substance. It is also known that the concentration of optically active substances can be measured by transmitting a polarised beam of light through the substance. For example U.S. Pat. No. 5,357,960 describes a method and an apparatus for quantitative determination of an optically active substance in vivo. WO 01/84121 A1 describes a method and a device for polarimetric measurement of the concentration of for example glucose in blood in vivo. The apparatuses and the methods disclosed in these documents are quite complicated, since the concentration of the substances to be measured in vivo is quite low. The inventor of the present invention has however realised that the concentrations to be measured in an apparatus according to the present invention, usually are very high. The inventor has therefore realised that a measurement unit arranged in an apparatus according to the present invention can be made quite simple and still give a very accurate measurement of the concentration of the substance in question.

It should be mentioned that the concepts dialysis fluid and infusion fluid in this document are not only meant to refer to the final dialysis or infusion fluid but also to a concentrate which is mixed with other concentrates and/or diluted in order to obtain the final dialysis or infusion fluid.

It should also be noted that when in this document “light” is mentioned, this concept is meant to cover not only electromagnetic radiation in the visible wavelength range but also electromagnetic radiation of other wavelengths.

According to a preferred embodiment, the apparatus includes a plurality of inlets for different matters, wherein the apparatus is arranged such that the different matters introduced via said inlets will be mixed with each other in said apparatus, wherein the measurement unit is positioned in or at said apparatus such that the concentration of said substance in said fluid is measured before the fluid has obtained its final form in the apparatus by being mixed with all the other matters introduced via said inlets. Before the fluid has been mixed with all the other matters, the fluid contains normally a higher concentration of the substance to be measured. Therefore, the invention is particularly useful to measure the concentration of the substance before the fluid has obtained its final form in the apparatus.

Preferably,.said plurality of inlets include a first inlet via which the fluid to be measured is to be introduced into the apparatus, wherein the measurement unit is positioned in or at the apparatus such that the concentration of said substance in said fluid is measured before said fluid, that is introduced via said first inlet, has been mixed in the apparatus with any other matter introduced via the other of said plurality of inlets. According to this embodiment, the concentration of the substance is thus measured before the fluid has been mixed with any other substance in the apparatus. The concentration of the substance in the fluid is therefore particularly high. Furthermore, if the concentration of the substance is found to be wrong, it is possible to stop the feeding of the fluid to the apparatus at an early stage.

According to a further embodiment, the measurement unit is designed to measure a concentration of said substance that is above 100 g/l. The measurement unit can particularly be designed to measure the concentration of a sugar in said fluid, preferably in the form of glucose. When the concentration of the substance is above 100 g/l it is particularly advantageous to use the present invention, since the measurement unit can be designed in a quite simple manner. Since the concentration of for example glucose that is fed from a concentrate to an apparatus is normally essentially higher than 100 g/l, the apparatus according to the present invention is particularly useful.

According to a further embodiment, the apparatus includes means arranged to generate a warning signal if the measured concentration of said substance in said fluid does not fulfil a predetermined requirement. The warning signal may for example be an electrical signal which indicates that a certain measure is to be carried out. For example, the signal may cause the dialysis process to stop and/or may cause a light or sound signal to be emitted as a warning to the operator of the apparatus.

According to a preferred embodiment, the apparatus includes an at least partly transparent conduit in said apparatus or at an inlet to said apparatus, through which transparent conduit the fluid to be measured is to pass, wherein said measurement unit is positioned and arranged to produce a polarised beam of light that is passed through the fluid to be measured at said at least partly transparent conduit. By passing the fluid through a transparent conduit, it is possible to pass a beam of light through the transparent conduit and thereby through the fluid.

The measurement unit is with advantage arranged to provide a plane-polarised beam of light. The measurement unit can thereby be arranged with measurement means that measure an entity that indicates with which angle the plane of polarisation of said polarised beam of light has rotated when said polarised beam of light has passed through the fluid. The measurement means can thereby comprise a light intensity detector. By measuring with which angle the polarised beam of light has been rotated in the fluid, a measure of the concentration of the optically active substance in the fluid is obtained.

The invention also relates to a system comprising an apparatus according to any of above embodiments and a container including a fluid, wherein the container is connected to the apparatus such that the fluid in the container is fed to the apparatus, and wherein said measurement unit is arranged to measure the concentration of said substance in the fluid from the container. With such a system, it is thus possible to measure whether the correct concentration of the substance in the fluid from the container is fed to the apparatus.

The container is preferably of the kind that includes at least two compartments, and wherein the contents of these compartments are to be mixed before the fluid leaves the container. The container can be a flexible fluid bag, in which the concentration of said substance to be measured is at least 100 g/l. As has been mentioned above, it is important to be able to measure whether the contents of the different compartments in such a container have been mixed correctly before the fluid is fed to the apparatus. This can be done in an efficient and accurate but still inexpensive manner with an apparatus or a system according to the invention.

The invention also relates to a method of carrying out a measurement of the concentration of an optically active substance in a dialysis and/or infusion fluid, which fluid is arranged to be fed to and/or through an apparatus for hemodialysis, hemodiafiltration, hemofiltration or peritoneal dialysis. The method comprises the steps of: providing a polarised beam of light; transmitting said polarised beam of light through said fluid; and detecting the influence that said substance in the fluid has on the polarised-beam of light which is passed through the fluid such that an indication of the concentration of said substance in the fluid is obtained. With such a method, advantages corresponding to those described above in connection with the apparatus and with the system are obtained.

The substance is preferably a sugar, such as glucose. The fluid can be a concentrate that is to be mixed with other substances and/or diluted in said apparatus. The fluid is preferably fed to said apparatus from a container, for example a flexible fluid bag, which can include at least two compartments, and wherein the contents of these compartments are mixed before the fluid leaves the container.

Further preferred manners of carrying out the method are described in the claims below and in the following description.

### BRIEF DESCRIPTION OF THE DRAWINGS

FIG. 1 shows schematically a dialysis apparatus and a system according to the present invention.

FIG. 2 shows schematically a measurement unit that can be used in the apparatus and in the system according to the invention.

FIG. 3 shows schematically an alternative embodiment of the measurement unit.

FIG. 4 shows a schematic flow chart of an embodiment of the method according to the invention.

### DESCRIPTION OF PREFERRED EMBODIMENTS

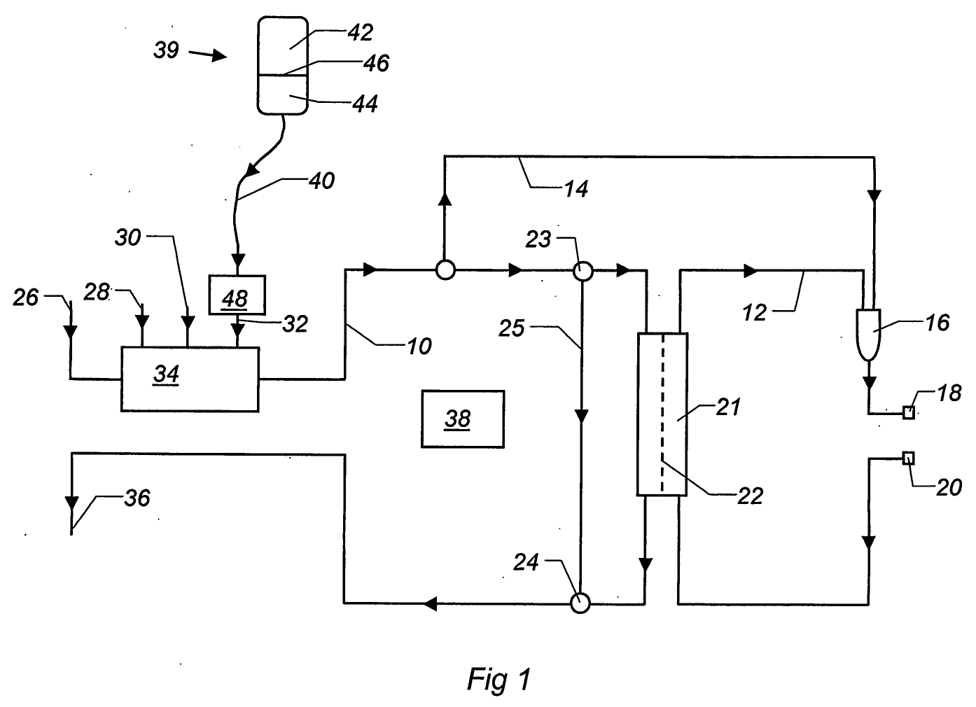

FIG. 1 shows schematically an apparatus according to the invention. The apparatus has a first flow circuit 10 for a dialysis solution and a second flow circuit 12 for blood. The apparatus according to this embodiment also has a conduit 14 for infusion solution. A drip chamber 16 is arranged as part of the second flow circuit 12. Also the conduit 14 leads to the drip chamber 16. The connections 18 and 20 are to be connected to a patient. A dialyser or hemofilter 21 is connected to the first flow circuit 10 and to the second flow circuit 12. The dialyser or hemofilter 21 is provided with a semi-permeable membrane 22. It should be mentioned that an apparatus for peritoneal dialysis does of course not have any dialyser 21, since in this case the peritoneum of the patient functions as a dialyser membrane.

A by-pass conduit 25 is arranged between valves 23 and 24. The valves 23 and 24 can thus be set such that the dialysis solution passes through the by-pass conduit 25 instead of through the dialyser 21.

In the shown embodiment, the apparatus has inlets 26, 28, 30 and 32. The number of inlets may of course vary from apparatus to apparatus. The inlet 26 is an inlet for pure water. The inlets 28, 30 and 32 constitute inlets for different concentrates which together with the water are to form the dialysis solution. The correct composition of the dialysis solution is prepared in a preparatory unit 34. An outlet for the dialysate is indicated by 36. 38 indicates a processor unit or a computer that controls the operation of the apparatus.

Since a dialysis apparatus is well known to a person skilled in the art, there is no need to show all the details of such an apparatus here. Neither is there any need to explain the function of such an apparatus in detail. The apparatus of course has many more parts, such as pumps, flow metres etc.

The apparatus described so far has a conventional construction known to a person skilled in the art.

The different concentrates needed for the dialyses solution may be fed to the apparatus from different containers. It is for example known that at least some concentrate can be fed from a container in the form of a fluid bag that contains two or more compartments. FIG. 1 shows schematically such a fluid bag 39 that is connected to the inlet 32. The fluid bag 39 is normally suspended at a level above the inlet 32 and is connected to the inlet 32 via a tube 40. In the shown example, the fluid bag 39 comprises two compartments 42 and 44. One compartment, for example the compartment 42, may include a glucose solution. Before the content of the bag 39 is fed to the inlet 32, the contents of the two compartments 42 and 44 are to be mixed with each other. This is done by opening a connection in a sealing 46 between the two compartments 42, 44. It is important that the sealing 46 is actually broken such that the contents of the two compartments 42 and 44 are mixed before the concentrate is fed to the inlet 32, because if this is not the case, then the correct concentrate would not be fed to the inlet 32. The concentration of the glucose in the compartment 42 may for example be 570 g/l. When the contents of the two compartments 42 and 44 have been mixed, the concentration of glucose in the concentrate that is fed to the inlet 32 should for example be 400 g/l.

In order to measure that actually the correct concentration of glucose is fed to the apparatus, the apparatus according to the present invention is provided-with a measurement unit 48. The measurement unit 48 is in this case arranged at the inlet 32. It should be noted that it is within the scope of the invention that the measurement 48 is arranged at other parts of the apparatus. For example, the measurement unit 48, or an additional measurement unit, could be positioned in the first flow circuit 10 or in the conduit 14. However, it is advantageous to arrange the measurement unit 48 at the inlet 32 for at least two reasons. Firstly, the concentration of the glucose is much higher at the inlet 32 than in other parts of, the apparatus. The measurement unit 48 does therefore not have to be so sensitive when it is positioned at the inlet 32. The measurement unit 48 can therefore be designed in a quite simple and inexpensive manner. Secondly, it is advantageous to position the measurement unit 48 at the inlet 32, since if the wrong concentration of glucose would be detected by the measurement unit 48, then the feeding of the concentrate from the fluid bag 39 can be stopped at an early stage.

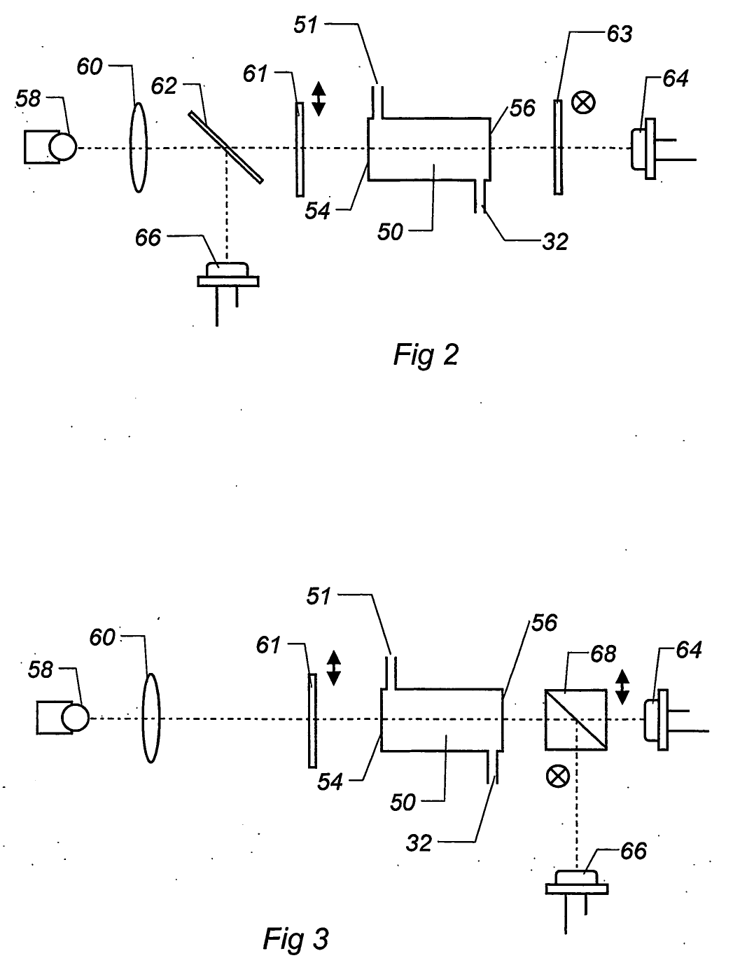

With reference to FIG. 2, the measurement unit 48 will be described in some more detail. The measurement unit 48 is arranged to measure an optically active substance. According to this example, the optically active substance is glucose. The measurement unit 48 is arranged to measure the concentration of the optically active substance, i.e. in this case glucose, by measuring the influence that the:substance in the fluid has on a polarised beam of light that is transmitted through -the fluid.

The theory of optical activity and how to measure with a polarised beam of light will not be described in all its details here, since this theory is known to a person skilled in the art and since the theory is described in different text books, such as Optics by Hecht and Zajec, Addison-Wesley Publishing Comp. 1974, see in particular pages 255-260. Basically, the measurement can be carried out by transmitting a plane-polarised beam of light through the fluid in question. The plane of polarisation will thereby be rotated when the beam of light passes through the fluid. The angle with which the plane of polarisation is rotated depends on the concentration of the optically active substance in the fluid as well on the distance through the fluid that the beam of light has passed. If the angle of rotation is measured, and if the distance through the fluid is known, the concentration of the optically active substance in the fluid may be calculated.

FIG. 2 thus schematically shows an embodiment of the measurement unit 48 that forms part of the apparatus according to the invention. The measurement unit 48 includes a sample cell 50. The fluid to be measured is included in the sample cell 50. The sample cell 50 can be positioned such that all the fluid that is to be measured passes through the sample cell 50. The inlet 51 to the sample cell 50 can be connected to the tube 40 from the container 39 (see FIG. 1). The fluid exits the sample cell 50 via an outlet 32. This outlet 32 can thus be an inlet to the preparatory unit 34 shown in FIG. 1. According to this embodiment, the measurement unit 48 is thus positioned in the apparatus such that the concentration of the glucose is measured before the fluid from the fluid bag 39 is mixed with any other substance that will be included in the dialysis, solution. The sample cell 50 has a first transparent window 54 and a second transparent window 56. The sample cell 50 is thus designed such that a beam of light can pass through the sample cell 50 and thereby through the fluid that is located in the sample cell 50. The first 54 and second 56 windows are preferably made of a material without internal birefringence, in order to avoid that these windows-54, 56 will have an influence on the measurement result.

The measurement unit also comprises a light source 58 that produces a beam of light that is passed through the sample cell 50. The light source 58 should preferably be monochromatic or near monochromatic. An inexpensive light emitting diode (LED) can be used as the light source 58. The light source 58 should produce a sufficiently collimated beam of light. If necessary, a collimating lens 60 may be positioned in the beam path from the light source 58. The beam of light passes through a beam splitter 62 that preferably reflects only a small portion of the light beam, while the major part of the light beam passes through the beam splitter 62. The beam that passes through the beam splitter 62 also passes through a first polariser 61 that produces a plane-polarised beam of light. It should be mentioned that the beam splitter 62 does not necessarily have to be positioned between the light source 58 and the polariser 61. The beam splitter 62 could also be positioned between the polariser 61 and the sample cell 50. In FIG. 2 it is indicated by arrows that the beam of light is polarised in the plane of the figure. When this plane-polarised beam of light passes through the sample cell 50, the plane of polarisation will be rotated depending on the distance between the first 54 and second 56 windows and depending on the concentration of an optically active substance in the sample cell 50.

After having passed through the sample cell 50, the beam of light passes through a second polariser 63. The second polariser 63 can for example be arranged such that the polarisation direction of the second polariser 63 is perpendicular to that of the first polariser 61. In FIG. 2 this is indicated by the symbol next to the polariser 63. According to another possible embodiment, the second polariser 63 (or the second polariser 63 together with the photo detector 64) can be arranged to be rotatable around the optical axis. In this case the angle with which the plane of polarisation of the polarised beam of light has rotated when the beam has passed through the fluid can be measured by rotating the second polariser 63 until a maximum (or, alternatively, a minimum) light intensity is detected by the photo detector 64. The rotational angle of the polariser 63 then indicates with which angle the plane of polarisation has been rotated.

The beam that has passed through the second polariser 63 impinges on a first photo detector 64. The photo detector 64 thus measures the intensity of light impinging thereon. If there is no optically active substance in the sample cell 50, the plane of polarisation of the light beam will not change when passing through the sample cell 50. If the second polariser 63 is arranged as in FIG. 2, the photo detector 64 will thus detect a minimum intensity of light. On the other hand, if there is an optically active substance of such a concentration in the sample cell 50 that the plane of polarisation is rotated 90° while passing through the sample cell 50, the photo detector 64 will detect a maximum intensity of light. When the optically active substance in the sample cell 50 is of such a concentration that the plane of polarisation will rotate between 0° and 90° , the photo detector 64 will detect an intensity of light that depends on the degree of rotation of the plane of polarisation. The detected light intensity at the photo detector 64 is proportional to sin²θ where θ is the angle of rotation of the plane of polarisation. By detecting the light intensity at the first photo detector 64, an indication of the concentration of the optically active substance in the fluid in the sample cell 50 is thus obtained. The length of the sample cell 50, i.e. a distance between the first 54 and second 56 windows, should be chosen such that a suitable rotation of plane of polarisation is obtained for the concentrations which are normally measured by the measurement unit 48. It has been found that a length of the sample cell 50 of between 5 mm and 60 mm, preferably between 10 mm and 40 mm is suitable for this application, when the concentration of the glucose to be measured is above 100 g/l, preferably above 300 g/l.

In the shown embodiment, the measurement unit 48 also comprises a second photo detector 66 that detects the beam reflected by the beam splitter 62. The second photo detector 66 is used to detect variation in the light intensity from the light source. Thereby the measurement detected by the first photo detector 64 can be compensated for such variation. The first and second photo detectors are preferably connected to a processor unit, for example to the processor unit 38 described in connection with FIG. 1. The concentration of the optically active substance in the fluid can be measured continuously while the fluid flows through the sample cell 50. However, it is also possible to measure this concentration intermittently and also when there is no flow through the sample cell 50.

Since the first 64 and second 66 photo detectors are connected to the processor unit 38, the processor unit 38 can be arranged to generate a warning signal if the measured concentration of the substance is outside a pre-set requirement. The warning signal may for example cause the dialysis process to stop, for example by setting the valves 23 and 24 such that the dialysis fluid passes through the by-pass conduit 25. A signal, such that a sound or light signal, can also be produced in order to warn the person operating the apparatus that the concentration in the fluid is not correct.

Another embodiment of the measurement unit 48 is schematically shown in FIG. 3. The same reference numbers are used for the corresponding components as in FIG. 2. According to this embodiment, there is no beam splitter 62 before the sample cell 50. The second polariser 63 in FIG. 2 has been substituted by a polarising beam splitter 68. The polarising beam splitter 68 can be designed such that light polarised in the plane of the figure is transmitted through the beam splitter 68 while light polarised perpendicular thereto is reflected by the beam splitter 68 towards the second photo detector 66. The ratio between the intensity detected by the photo detector 64 and the photo detector 66 thus depends on the rotation of the plane of polarisation, and thereby on the concentration of the optically active substance in the sample cell 50. The embodiment of FIG. 3 has the advantage that since the ratio between the intensity detected by the photo detector 64 and the photo detector 66 is analysed, a variation in the intensity of the light emitted from the light source 58 does not influence the detection. Furthermore, the opacity of the fluid in the sample cell 50 does not influence the result of the measurement. It should be noted that FIG. 2 and FIG. 3 schematically show two possible embodiments of the measurement unit 48. Modifications of or alternatives to these embodiments are evident to a person skilled in the art without departing from the scope of the present invention.

A system according to the invention comprises an apparatus as described above together with a container 39 including the fluid to be analysed; for example a container in the form of a fluid bag 39. FIG. 1 thus also illustrates an embodiment of a system according to the invention. As explained above, the fluid bag 39 may comprise a plurality of compartments 42, 44. The concentration of the substance, such as glucose, that is fed from the fluid bag 39 to the apparatus is preferably at least 100 g/l, more preferred at least 300 g/l. A measurement unit 48 that is included in the invention is particularly useful for measuring such relatively high concentrations, since the measurement unit can be constructed in a simple and inexpensive manner.

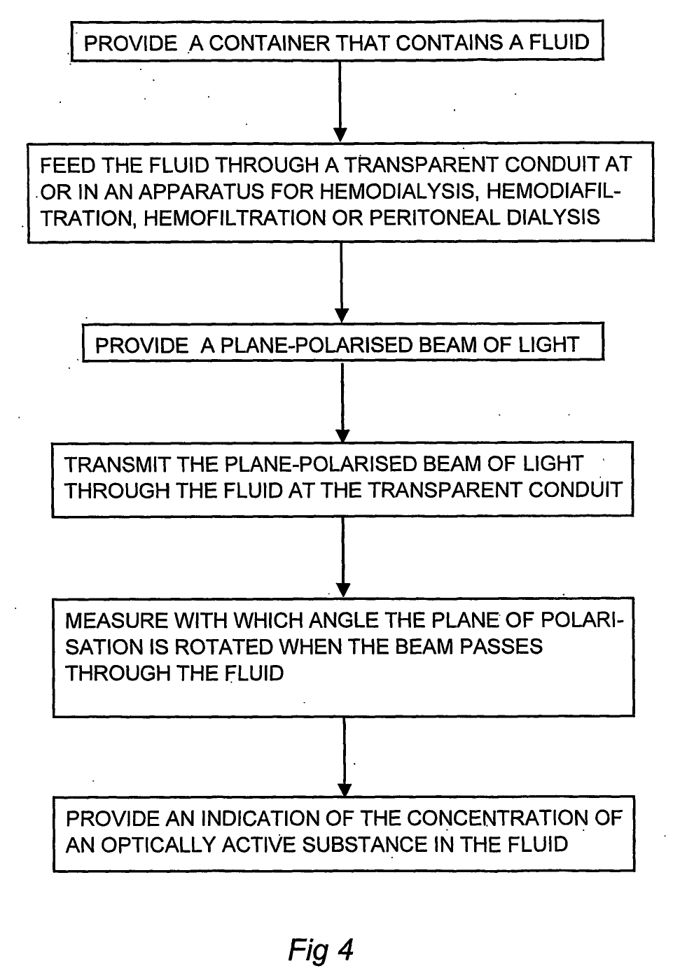

FIG. 4 schematically shows a flow chart of a method according to the invention for carrying out a measurement of the concentration of an optically active substance in a dialysis and/or infusion fluid, which fluid is arranged to be fed to and/or through an apparatus for hemodialysis, hemodiafiltration, hemofiltration or peritoneal dialysis. According to this example of how to carrying out the method, the method comprises the following steps.

A container 39 is provided. The container 39 is a flexible fluid bag 39 with at least two compartments 42, 44.The contents of the two compartments 42, 44 are to be mixed before the fluid leaves the container 39. The concentration of the substance in the fluid at the position where the measurement is carried out is to be at least 100 g/l. The fluid is fed from the container 39 to the apparatus. The fluid passes through an at least partly transparent conduit 50, preferably at an inlet 32 to the apparatus. A plane-polarised beam of light is produced. The plane-polarised beam of light is transmitted through the fluid. An entity is measured that indicates with which angle the plane of polarisation of the polarised beam of light has been rotated when passing through the fluid. An indication of the concentration of the substance is thus obtained.

The invention is not limited to the described embodiments but may be varied and modified within the scope of the following claims.

1. An apparatus for hemodialysis, hemodiafiltration, hemofiltration or peritoneal dialysis, comprising at least one conduit in which a dialysis and/or infusion fluid is intended to flow, comprising a measurement unit for measuring at least one substance in said fluid, said substance being optically active, wherein the measurement unit is arranged to measure the concentration of said substance in said fluid by measuring the influence of said substance on a polarized beam of light transmitted through said fluid.

2. An apparatus according to claim 1, further comprising a plurality of inlets for different matters, said different matters being mixed with each other after being introduced via said inlets, wherein the measurement unit is configured to measure the concentration of said substance in said fluid before the fluid is mixed with the other different matters introduced via said inlets.

3. An apparatus according to claim 2, wherein said plurality of inlets include a first inlet for introducing the fluid to be measured into the apparatus, said measurement unit being configured to measure the concentration of said substance in said fluid before said fluid, that is introduced via said first inlet, is mixed in the apparatus with any other different matters introduced via another of said plurality of inlets.

4. An apparatus according to claim 1, wherein said measurement unit is designed to measure a concentration of said substance above 100 g/l.

5. An apparatus according to claim 1, wherein said measurement unit is designed to measure the concentration of a sugar in said fluid.

6. An apparatus according to claim 5, wherein said sugar is glucose.

7. An apparatus according claim 1, further comprising means arranged to generate a warning signal if the measured concentration of said substance in said fluid does not fulfill a predetermined requirement.

8. An apparatus according to claim 1, further comprising an at least partly transparent conduit in said apparatus or at an inlet to said apparatus, said transparent conduit being configured to carry the fluid to be measured, wherein said measurement unit is configured to produce a polarized beam of light that is passed through the fluid to be measured at said at least partly transparent conduit.

9. An apparatus according to claim 1, wherein said measurement unit is arranged to provide a plane-polarized beam of light.

10. An apparatus according to claim 9, wherein said measurement unit further comprises a measurement device to measure an entity, said entity indicating the angle at which the plane of polarization of said polarized beam of light has rotated when said polarized beam of light has passed through the fluid.

11. An apparatus according to claim 10, wherein said measurement device comprises a light intensity detector.

12. A system comprising an apparatus according to any claim 1, further comprising a container housing a fluid, wherein the container is connected to the apparatus to allow the fluid housed in the container he to be fed to the apparatus, and said measurement unit is arranged to measure the concentration of said substance in the fluid fed from the container.

13. A system according to claim 12, wherein the container includes at least first and second compartments having contents, the contents of the first and second compartments being mixed before the fluid leaves the container.

14. A system according to claim 12, wherein said container is a flexible fluid bag.

15. A system according to claim 12, wherein the concentration of said substance in said container is at least 100 g/l.

16. A method for carrying out a measurement of the concentration of an optically active substance in a dialysis and/or infusion fluid, comprising the steps of:
feeding a fluid to and/or through an apparatus for hemodialysis, hemodiafiltration, hemofiltration or Peritoneal dialysis;
providing a polarized beam of light;
transmitting said polarized beam of light through said fluid; and
detecting the influence of said substance on the polarized beam of light which is passed through the fluid to measure the concentration of said substance in the fluid.

17. A method according to claim 16, wherein said substance is a sugar.

18. A method according to claim 17, wherein said sugar is glucose.

19. A method according to claim 16, wherein said fluid is a concentrate that is to be mixed with other substances and/or diluted in said apparatus, said concentration measurement on said fluid being made before the fluid is mixed with other substances and/or diluted in said apparatus.

20. A method according to claim 16, wherein said fluid is fed to said apparatus from a container.

21. A method according to claim 20, wherein said container includes at least first and second compartments having contents, the contents of the first and second compartments being mixed before the fluid leaves the containers.

22. A method according to claim 20 or 21, wherein said container is a flexible fluid bag.

23. A method according to claim 16, wherein the concentration of said substance in said fluid at the position where the measurement is carried out is at least 100 g/l.

24. A method according to claim 16, further comprising the step of generating a warning signal if the measured concentration of said substance in said fluid does not fulfill a predetermined requirement.

25. A method according to claim 16, wherein said feeding step further comprises the sub-step of:
feeding said fluid through an at least partly transparent conduit in said apparatus or at an inlet to said apparatus, wherein said polarized beam of light is transmitted through said fluid at said at least partly transparent conduit.

26. A method according to claim 16, wherein said polarized beam of light is a plane-polarized beam of light.

27. A method according to claim 26, wherein the step of detecting the influence of said substance on the polarized beam of light further comprises measuring an entity indicating the angle the plane of polarization of said polarized beam of light has rotated when said polarized beam of light has passed through the fluid.
